(19) United States
(12) Patent Application Publication
(10) Pub. No.: US 2014/0053785 A1
(43) Pub. Date: Feb. 27, 2014

(54) Holder for Flexible Sheet Material

(71) Applicants: Tristan Christianson, San Francisco, CA (US); Charles Floyd, San Francisco, CA (US); Robert E. Miller, San Francisco, CA (US); Mark Martin, San Francisco, CA (US)

(72) Inventors: Tristan Christianson, San Francisco, CA (US); Charles Floyd, San Francisco, CA (US); Robert E. Miller, San Francisco, CA (US); Mark Martin, San Francisco, CA (US)

(73) Assignee: ABSOLUTELYNEW, INC., San Francisco, CA (US)

(21) Appl. No.: 13/593,083

(22) Filed: Aug. 23, 2012

(51) Int. Cl. A01K 29/00

(52) U.S. Cl. 119/169

(57) ABSTRACT

A holder for storing and securing flexible sheet materials is provided. The holder includes a base member surrounded by a vertical wall forming a reservoir. The base member has at least one attachment structure for receiving and retaining a plurality of liquid absorptive sheets that are stacked one on top of another. The attachment structure includes a plurality of slits that can be deflected to receive the sheet material.

### RELATED APPLICATION

This application claims priority to a previously filed provisional application 61/525,946, filed on Aug. 23, 2011.

### TECHNICAL FIELD OF THE INVENTION

The invention relates to a device that securely holds a flexible sheet material. More particularly, the preferred embodiment of the invention manifests as a holder for liquid absorptive sheets used by domestic pets.

### BACKGROUND OF THE INVENTION

Devices that ease the arduous task of housebreaking a domestic pet are well known in the art. Even after housebreaking is successful, these devices are useful when a dog that has been trained to use liquid absorptive sheets is left indoors for extended period of time. Such devices are disclosed, for example, in U.S. Pat. Nos. 4,715,320; 6,059,247; 5,630,376; 4,949,673; 5,355,837; and the references cited therein. These devices hold newspaper or an absorbent sheet of material in place to prevent a dog's waste from leaking onto a floor surface and allow a dog to eliminate in a predetermined area. The absorbent sheet of material held by most prior art devices is a leak-proof pad having a plastic backing that prevents waste from leaking through the pad and onto a floor surface. Some of the prior art devices use trays or reservoirs to prevent waste from leaking onto the floor surface. Another device, U.S. Pat. No. 4,715,320, uses three hoops to loosely retain newspaper or other material to prevent waste from leaking.

However, many of the prior art devices contain complicated parts, are hard to assemble and are bulky. Other devices are not durable enough to withstand the repeated weight of a large dog or render it difficult to remove a soiled sheet of material. A device is therefore needed that securely holds a disposable, absorbent pad in place, discourages a dog from chewing or dragging the absorbent pad, is inexpensive, is easy to manufacture, has simple but reliable parts, can be packaged and stored compactly and is easy to assemble. The device also needs to be durable and allow for the easy removal of a soiled pad. These and other advantages are provided by the invention disclosed below.

### SUMMARY OF THE INVENTION

A holder for flexible sheet material is disclosed. The holder for flexible material comprises of a plurality of attachment structures that can hold and secure a plurality of stackable flexible sheet materials, and can be easily transported by rolling the pad into a more transferrable form.

In the preferred embodiment, the holder for flexible sheet material is made of flexible materials. A pair of handles is provided and each handle is located in a symmetrically opposing position from the other. A user can insert his or her hands into both handles, folding the holder into a more convenient carrying form. At least one loop and at least one button is provided as well in the preferred embodiment, such that the user can alternatively roll up the holder and secure the rolled up form with the loop and button.

### BRIEF DESCRIPTION OF THE DRAWINGS

FIG. 1 is a perspective view of a preferred holder for flexible sheet material made in accordance with the present invention;

FIG. 2 is an isometric view of the bottom side of the holder.

FIG. 3 is an isometric view of an embodiment of the holder, with a flexible sheet material overlying the holder for flexible material.

FIG. 4 is an isometric view of the holder securely holding flexible sheet material.

FIG. 5 is an embodiment of the holder in its rolled up form.

FIG. 6 is an embodiment of the holder in its folded up form.

FIG. 7 is a perspective view of an attachment structure.

FIG. 8 is a vertical cut-out section of an attachment structure, showing the cavity within.

FIG. 9 is a top view of a plurality of attachment structures.

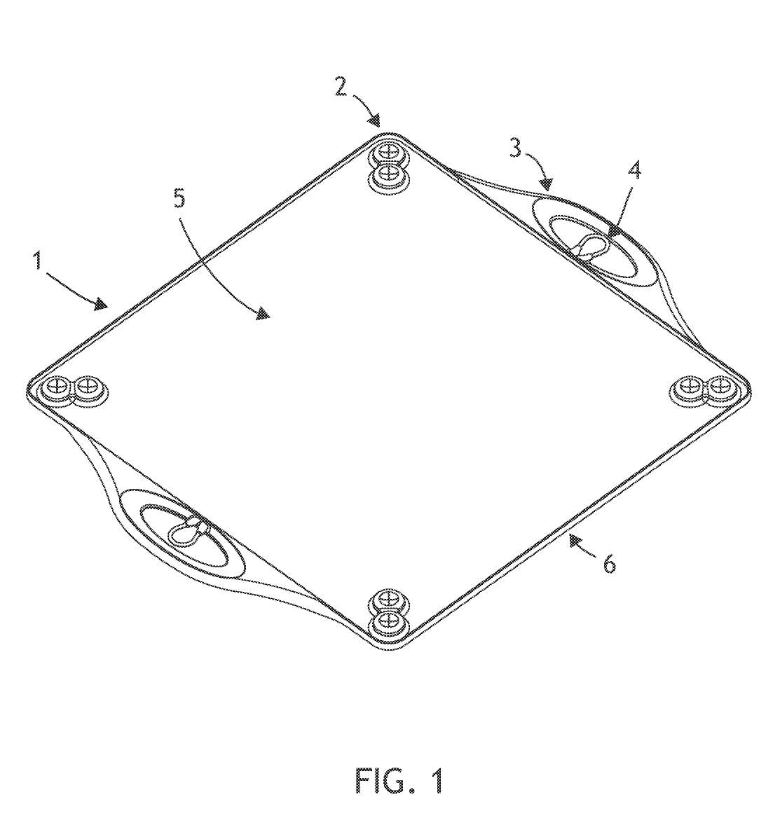

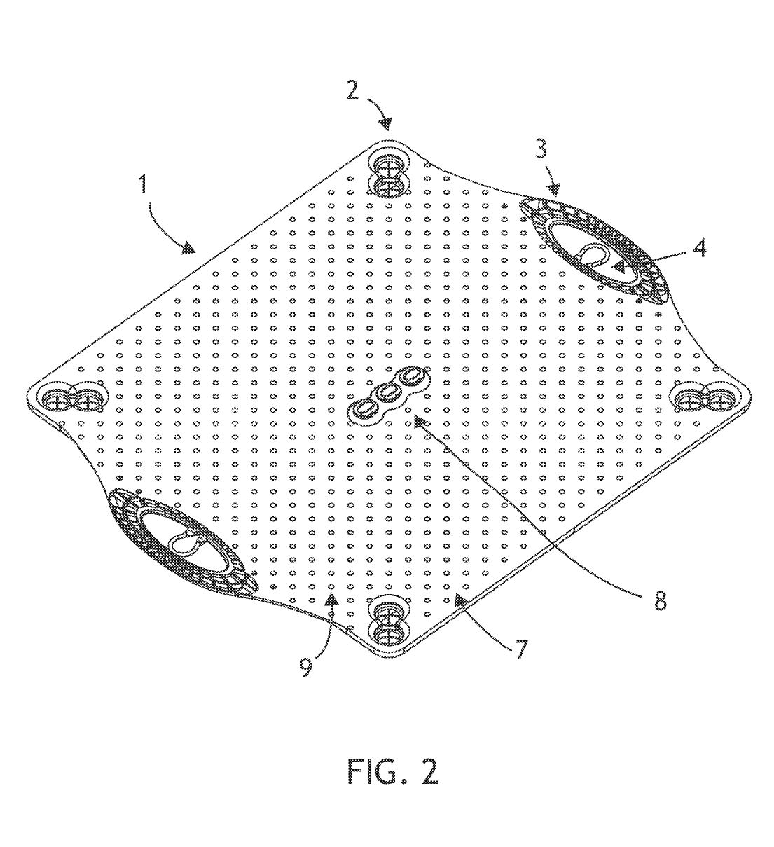

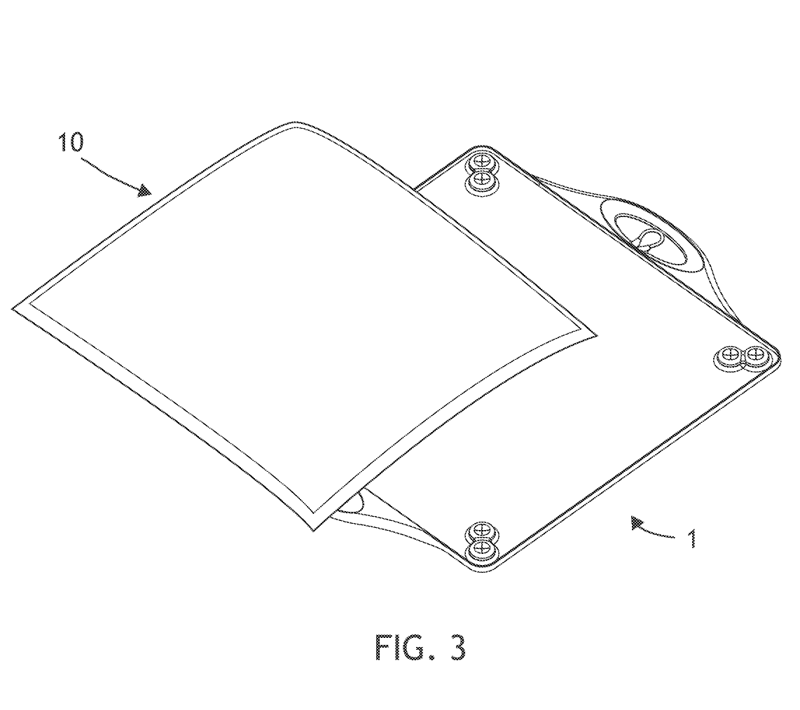

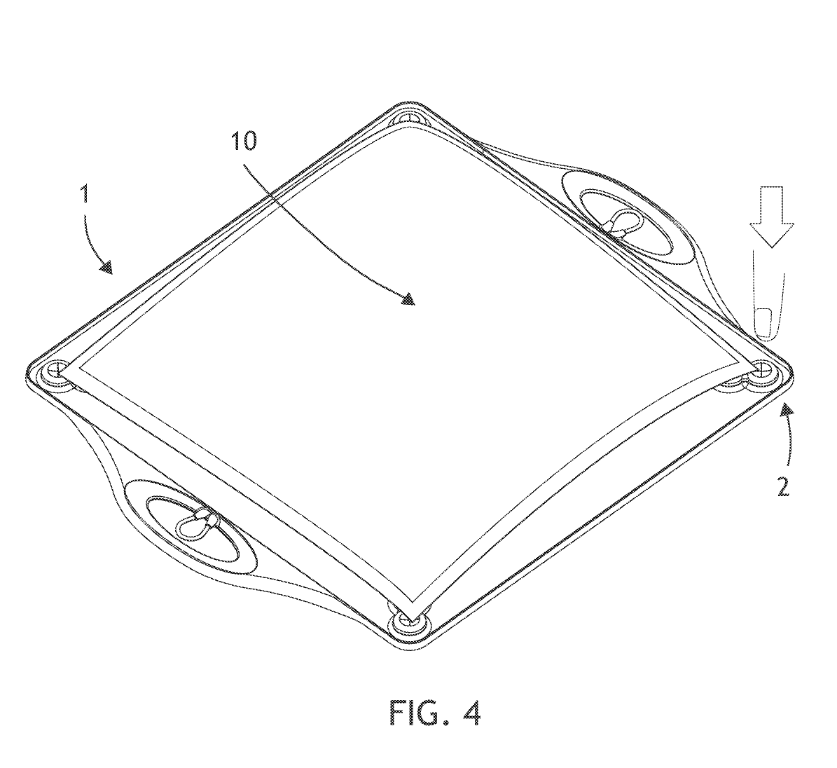

### REFERENCE NUMERALS

1 Holder for flexible sheet material
2 Attachment structure
3 Carrying handle
4 Fastening loop
5 Base member
6 Raised wall
7 Bottom surface
8 Button
9 Dimples
10 Flexible sheet material
11 Cavity
12 Circular opening
13 Flexible flap

### DETAILED DESCRIPTION OF THE PREFERRED EMBODIMENT

In the preferred form of embodiment of this invention, the holder for flexible material manifests as a flexible holder for securing liquid absorptive sheets used for collecting waste of domestic pets. It should be clear for a person having skill in the art that the present invention can be implemented for applications other than the preferred form, and this disclosure aims to capture the spirit of the invention for securing flexible sheet materials beyond liquid absorptive sheets.

The holder for flexible material 1 can hold a plurality of flexible sheet material 10, securely holding the sheets during use by inserting the corners of the sheets into the attachment structures 2 located on the corners of the holder for flexible material 1. The attachment structures 2 illustrated in the preferred embodiment drawings are slightly raised above the flat surface of the holder for flexible material in order to secure a plurality of flexible sheet materials 10 that can be securely stacked one top of another.

The attachment structures 2 are preferably disposed at the corners of the base member, although these locations can be varied depending upon the size and shape of the flexible material sheet and the base member of the holder. The attachment structures 2 each comprise a plurality of intersecting slits 14 which extend through the flexible material which forms the flexible flaps 13. Various configurations of the slits are well known in the market for the purposes of securing a sheet material.

The slits 14 and through the flexible material of the attachment structure 2 allow the flexible flaps 13 to deflect under finger pressure so that a portion of the sheet can be inserted into a cavity 11 formed within the attachment structures 2. The end of the slits preferably terminate with a substantially circular opening 12. The circular openings 12 are well known in the industry to prevent stress cracking, which can be caused by repeated deflections of the attachment structure's flexible material during use.

The dimples 9 on the bottom side of the holder for flexible material 1 are designed to reduce weight and increase traction on the floor to prevent pets and users from accidentally slipping when stepping on the mat.

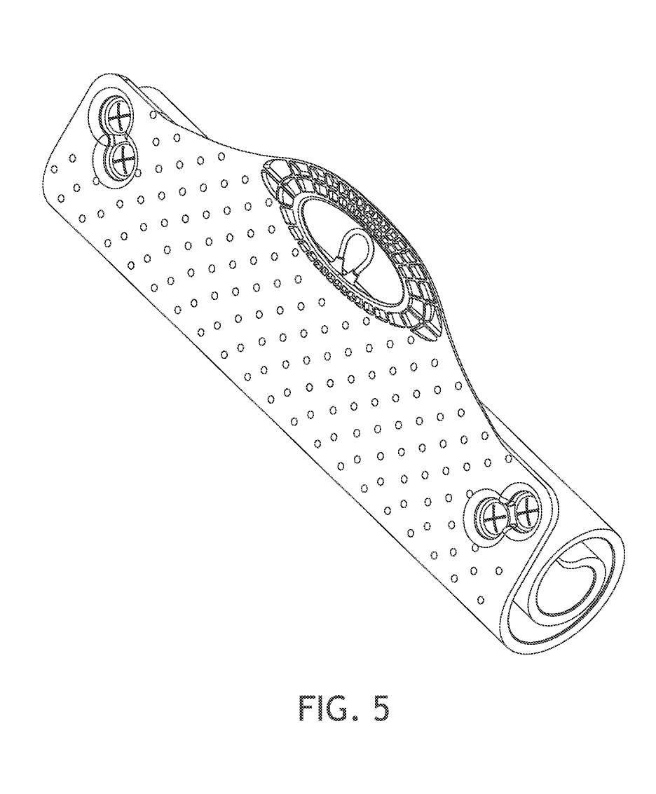

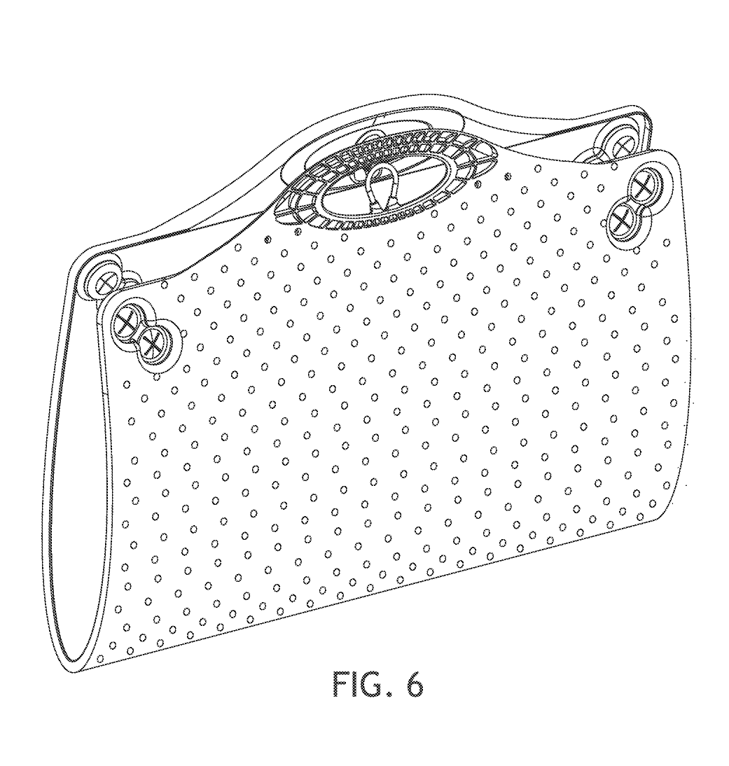

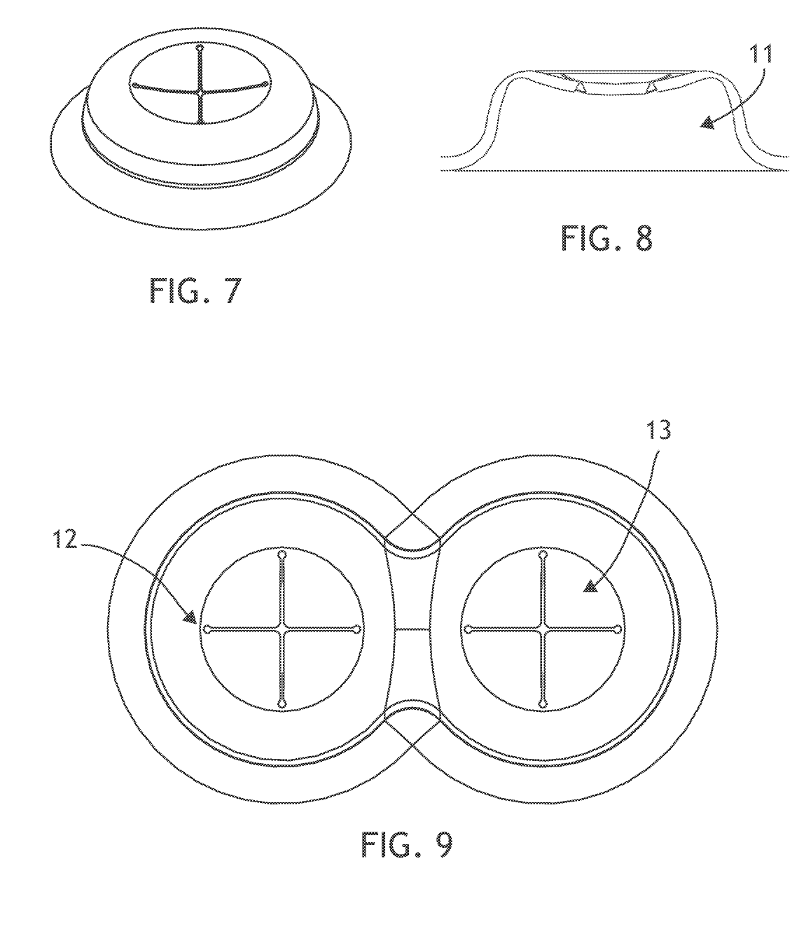

The raised walls 6 forms a reservoir with the base member 5, preventing accidental spillage of waste and further secure the flexible sheet materials 10 from being disturbed from its secure place by pets attempting to use the mat or persons who accidentally walk over the mat. The raised walls 5 are also used to prevent any flexible sheet materials 10 from slipping out during transport when the holder for flexible material is rolled up or folded in half seen in FIGS. 5 and 6 respectively.

The carrying handles 3 can be used in two separate ways: as a carrying handle when the holder for flexible material 1 is rolled up as seen in FIG. 5, or as a carrying handle and holder when the mat is being folded in half as seen in FIG. 6. The fastening loop 4 and button 8 are used in conjunction when the holder needs to be rolled up.

In the preferred embodiment, the holder for flexible material 1 is made entirely of materials that have the characteristics of thermoplastic elastomer (TPE) family. The holder for flexible material should have the ability to be stretched to moderate elongations, and upon the removal of stress, return to its original shape. This is an important characteristic in the preferred embodiment because domestic pets are well known to chew or play with soft, pliable objects, such that it is necessary for the holder for flexible material to withstand moderate amount of stretching and deformation and retains its original shape afterwards. The flexible material also allows the holder to be folded and rolled up for storage and transportation purposes.

The foregoing description of the preferred embodiments of the invention have been presented for purposes of illustration and description. It is not intended to be exhaustive or to limit the invention to the precise form disclosed. Modifications or variations are possible and contemplated in light of the above teachings by those skilled in the art, and the embodiments discussed were chosen and described in order to best illustrate the principles of the invention and its practical application. It is intended that the scope of the invention be defined by the claims appended hereto.

1. An holder for flexible sheet material, comprising:
a base member surrounded by a vertical wall forming a reservoir;
at least one attachment structure disposed on said base member for receiving and retaining at least one flexible sheet material;
wherein said attachment structure is formed from a flexible material;
wherein said attachment structure further comprises of a plurality of slits intersecting each other;
wherein each of said slits terminates at one end with a substantially circular opening, and said slits can be deflected to receive said sheet.

2. A holder for flexible sheet material of claim 1, where said base member comprises a plurality of said attachment structures.

3. A holder for flexible sheet material of claim 1, where said holder for flexible sheet material is made entirely of elastic materials.

4. A holder for flexible sheet material of claim 3, where said elastic material is from the thermoplastic elastomer category.

5. A holder for flexible sheet material of claim 1, further comprising at least one carrying handle.

6. A holder for flexible sheet material of claim 5, further comprising an additional carrying handle symmetrically opposing the first carrying handle.

7. A method for using a holder for flexible sheet material of claim 5, where a user can fold said holder for flexible sheet material and joining the handles together.

8. A holder for flexible sheet material of claim 1, further comprising of dimples on the bottom surface of said holder for flexible material that touches the ground.

9. A holder for flexible sheet material of claim 1, further comprising means of securing said holder for flexible sheet material in a rolled up position.

10. A holder for flexible sheet material of claim 7, where said means of securing said holder for flexible sheet material in a rolled up position comprises of at least one loop and at least one button.

11. A holder for flexible sheet material of claim 7, where said means of securing said holder for flexible material in a rolled up position comprises of hook and loop fastener.

12. A holder for flexible sheet material of claim 1, where said flexible sheet material is a liquid absorptive sheet.
